(19) United States
(12) Patent Application Publication
(10) Pub. No.: US 2012/0053496 A1
(43) Pub. Date: Mar. 1, 2012

(54) MANUAL AND CYCLONIC MASSAGE DEVICE

(76) Inventor: Dong-Her WU, Pu Yen Hsiang (TW)

(21) Appl. No.: 12/898,864

(22) Filed: Oct. 6, 2010

(30) Foreign Application Priority Data
Aug. 24, 2010 (TW) 99216319

(51) Int. Cl. A61H 7/00

(52) U.S. Cl. 601/97

(57) ABSTRACT

A manual and cyclonic massage device includes a retractable rod unit and a massage unit. The retractable rod unit comprises a push rod. One end of the push rod is connected with a handle, and another end of the push rod is connected with a push member. The push member is inserted in a hollow cylinder. A first end of the cylinder is threadedly connected with a cap to confine the push member after the push rod is inserted through the cap, and a second end of the cylinder is provided with a stop ring. A spring is provided between the stop ring and the push member to turn a fan of the massage unit in a cyclonic way. A front end of an axle of the fan is connected with an eccentric block having an eccentric axle. The eccentric axle is pivotally connected with a second bearing which is disposed at a central portion of a massage block. When the push rod is moved inward or ward, the push rod will be pushed by the elastic force and restore force of the spring to push air toward the fan. The fan is rotated to drive the eccentric axle of the eccentric block to turn. The eccentric axle drives the second bearing to turn the massage block, so the massage block can massage the desired massage portion.

### BACKGROUND OF THE INVENTION

1. Field of the Invention

The present invention relates to a manual and cyclonic massage device, and more particularly to one having a retractable rod unit and a massage unit. The retractable unit is moved inward and outward to drive a massage block of the massage unit to turn clockwise and counterclockwise so as to massage the user's arm, neck, chest, waist, abdomen, and so on.

2. Description of the Prior Art

The different between an abdomen exerciser and a power-driven device which is used to massage abdomen or a manual massage device is that the abdomen exerciser is transversely placed in front of the user's abdomen and pushed toward the abdomen by the user's hand. The abdomen exerciser will be pushed outward after the abdomen bears the pressure so as to exercise the user's upper body.

The pad of the conventional abdomen exerciser is contact with the body and the abdomen in a fixed way. When in use, the abdomen exerciser applies a force to the muscles of the abdomen frontward and rearward in a horizontal direction. This operation can exercise the user's upper body, but it cannot massage the fat of the user's abdomen.

Therefore, an improved abdomen exerciser to provide an abdomen pad which can massage and vibrate the abdomen is development. As shown in FIG. 1, FIG. 1-A, the abdomen exerciser comprises a retractable portion 5 at the middle of the abdomen exerciser and an abdomen pad 6. The retractable portion 5 includes a retractable rod 51 and a sleeve 52. The retractable rod 51 has threads 511 thereon. The lower end of the sleeve 52 is provided with block 521 corresponding to the threads 511, so that the block 521 is moved along the threads 511. The abdomen pad 6 includes an outer pad 61 and an inner pad 62 with is wrapped by the outer pad 61. The top of the inner pad 62 is coupled to the bottom of the retractable rod 51 to be linked by the retractable rod 51. The bottom of the inner pad 62 is provided with a plurality of protrusions 621. The outer pad 61 includes a pad block 612 and a wrapping surface 611. The pad block 612 has a plurality of ribs 613 thereon. The wrapping surface 611 is used to wrap the inner pad 62 and the pad block 612. The pad block 612 is located under the inner pad 62. The retractable rod 51 is rotated to vibrate the abdomen pad 6 so as to massage the user's abdomen.

As shown in FIG. 2, FIG. 2-A, a power-driven massage device comprises a housing 7, a motor 71 in the housing 7, and a lid 72 in conjunction with the housing 7 to cover the motor 72. The motor 72 has an axle 721 to connect with a massage unit 8. The massage unit 8 comprises a rotary member 81 and a massage member 82. The rotary member 81 includes an eccentric fixing portion 811, a protruding axle 812, and a balance weight portion 813. The massage member 82 has a massage surface 821 and a pivot portion 822 which extends inward from the massage surface 821. The protruding axle 812 is pivotally connected to the pivot portion 822. The protruding axle 812 is rotatable relative to the pivot portion 822. The massage member 82 is eccentricly rotated, with the massage surface 821 to get contact with the user's body. The counterforce will be counterbalanced through the protruding axle 812 and the pivot portion 822. At this time, the massage member 82 is rotated slowly. The torsional force outputted from the axle 721 of the motor 72 in conjunction with the balance weight portion 813 of the massage member 81 generates a massage motion. With the pivot portion 822 and the protruding axle 812 as a rotation center, the massage surface 821 is used to massage the user.

However, the former abdomen exerciser is operated in a horizontal direction to provide a slight vibration. The effect to massage the fat of the abdomen is limited. The vibration of the abdomen pad and the user's applying force are in the same direction, which results in that it is not easy to turn the abdomen pad 6. The expected effect to massage the abdomen cannot be achieved. The latter power-driven massage device only massages the contact portion.

Therefore, the present invention is to provide a manual and cyclonic massage device, which can be reciprocated to massage the abdomen.

### SUMMARY OF THE INVENTION

According to a first aspect of the present invention, there is provided a manual and cyclonic massage device which comprises a retractable rod unit and a massage unit. The retractable rod unit comprises a push rod. One end of the push rod is connected with a handle, and another end of the push rod is connected with a push member. The push member is inserted in a hollow cylinder. A first end of the cylinder is threadedly connected with a cap to confine the push member after the push rod is inserted through the cap. A second end of the cylinder is provided with a stop ring. A spring is provided between the stop ring and the push member for the push rod to reciprocate in the cylinder. The massage unit is connected to the second end of the cylinder. The massage unit comprises a first bearing fixed at the second end of the cylinder. A fan is provided in the first bearing. The fan has an annular limit board around a circumferential portion thereof to be located at one side of the first bearing. A limit plate is fitted on a central axle of the fan and located at another side of the first bearing. A front end of the axle is connected with an eccentric block having an eccentric axle. The eccentric axle is pivotally connected with a second bearing which is disposed at a central portion of a massage block. When applying a force inward, the push rod will be moved inward and pushed reversely by the elastic force of the spring. The push member connected to the push rod pushes air toward the fan. The fan is rotated to drive the eccentric axle of the eccentric block to turn. The eccentric axle drives the second bearing to turn the massage block, so the massage block can massage the desired massage portion. When the push rod is released, the push member is pushed back by the spring. The push member brings the push rod to move outward. Meanwhile, the push member inhales air for the fan to turn reversely. The eccentric axle of the eccentric block is also turned reversely. The eccentric axle drives the second bearing to turn the massage block reversely, so the massage block can massage the desired massage portion reversely.

According to a second aspect of the present invention, there is provided a manual and cyclonic massage device which comprises a retractable rod unit and a massage unit. One end of the push rod of the retractable rod unit is provided with a T-shaped rod which has two handles at two ends thereof. The retractable rod unit includes a protection cylinder which is connected with the first end of the cylinder. The push rod is located in the protection cylinder. The protection cylinder has a bottom end formed with two grooves to receive two resilient strips of a bow-shaped frame. The second end of the cylinder is connected to an opening disposed at a central portion of the bow-shaped frame. The bow-shaped frame functions as the spring in the cylinder, providing the elastic force and restore force to the retractable rod unit when being retraced inward or released.

According to a third aspect of the present invention, there is provided a manual and cyclonic massage device which comprises a retractable rod unit and a massage unit. The retractable rod unit includes a hollow protection cylinder which has a T-shaped rod at one end thereof. The T-shaped rod has two handles at two ends thereof. The protection cylinder is fitted on a retractable cylinder. The retractable cylinder is fitted on an outer cylinder. The retractable cylinder has two inner engaging grooves and two outer engaging blocks at two sides thereof. The engaging blocks are adapted to hold against a bottom edge of the protection cylinder. One end of the push rod is connected to a top of the protection cylinder, and another end of the push rod is connected with the push member and inserted in the cylinder. The cylinder is connected with a fixing plate to connect with the outer cylinder. Two sides of a top of the outer cylinder are pivotally connected with a pair of fixed pulleys for two resilient strips to sit thereon. Two ends of each resilient strip are connected to the fixing plate and the bottom of the retractable cylinder, respectively. The resilient strips are reciprocated in the engaging grooves to function as the spring in the cylinder, providing the elastic force and restore force to the retractable rod unit when being retraced inward or released.

### BRIEF DESCRIPTION OF THE DRAWINGS

FIG. 1 is a perspective view of a conventional abdomen exerciser;

FIG. 1-A is a front view of the conventional abdomen exerciser;

FIG. 2 is an exploded view of a conventional power-driven massage machine;

FIG. 2-A is a cross-sectional view of the conventional power-driven massage machine;

FIG. 3 is an exploded view according to a first embodiment of the present invention;

FIG. 3-A is a perspective view of the fan according to the first embodiment of the present invention;

FIG. 4 is a perspective view according to the first embodiment of the present invention;

FIG. 5-A is a cross-sectional view according to the first embodiment of the present invention;

FIG. 5-B is a cross-sectional view in an operated status according to the first embodiment of the present invention;

FIG. 6 is a schematic view showing the operation of the massage block according to the first embodiment of the present invention;

FIG. 6-A is a front view of the massage block according to the first embodiment of the present invention;

FIG. 7 is a perspective view according to a second embodiment of the present invention;

FIG. 7-A is a cross-sectional view according to the second embodiment of the present invention;

FIG. 8 is an exploded view according to a third embodiment of the present invention;

FIG. 8-A is a partially perspective view showing the resilient strips on the fixed pulleys according to the third embodiment of the present invention;

FIG. 8-B is a top view showing the resilient strips on the fixed pulleys according to the third embodiment of the present invention;

FIG. 9-A is a perspective view according to the third embodiment of the present invention;

FIG. 9-B is another perspective view according to the third embodiment of the present invention;

FIG. 10-A is a cross-sectional view according to the third embodiment of the present invention; and

FIG. 10-B is another cross-sectional view in an operated status according to the third embodiment of the present invention; and

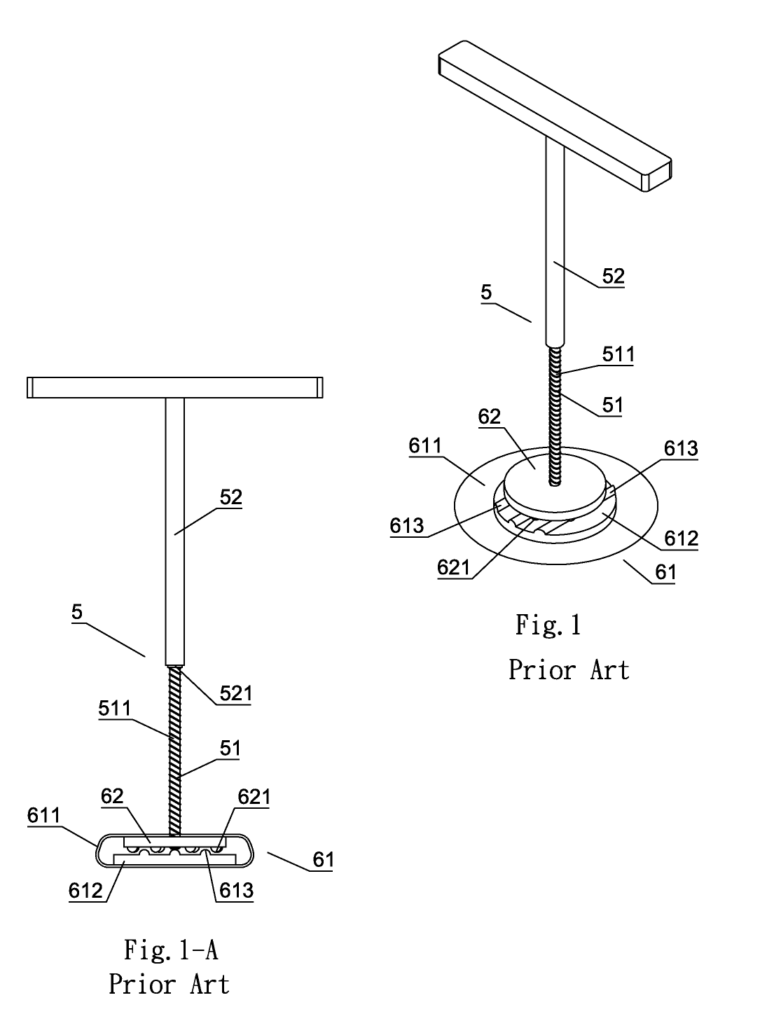

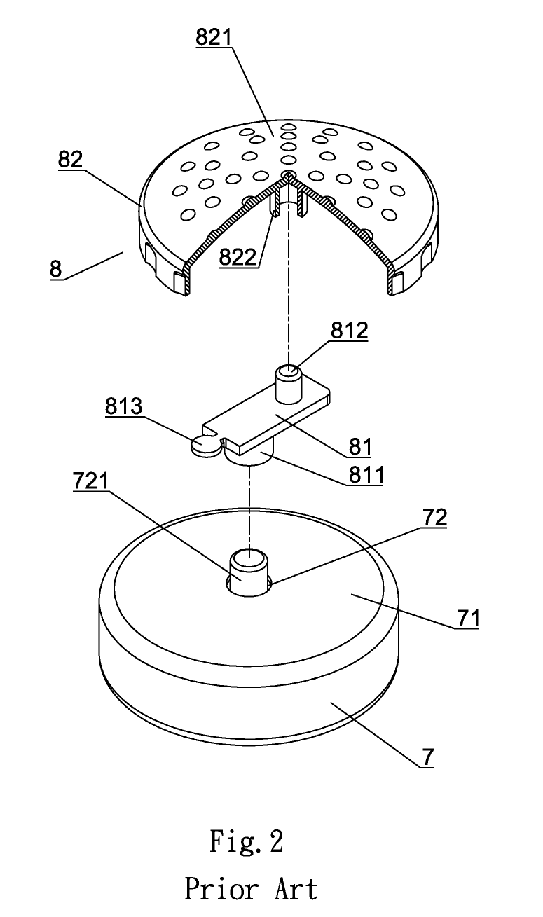

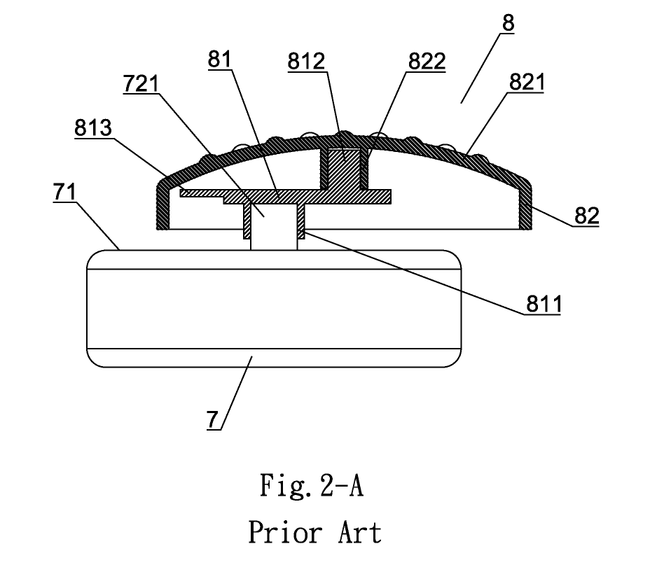

### DETAILED DESCRIPTION OF THE PREFERRED EMBODIMENTS

Embodiments of the present invention will now be described, by way of example only, with reference to the accompanying drawings.

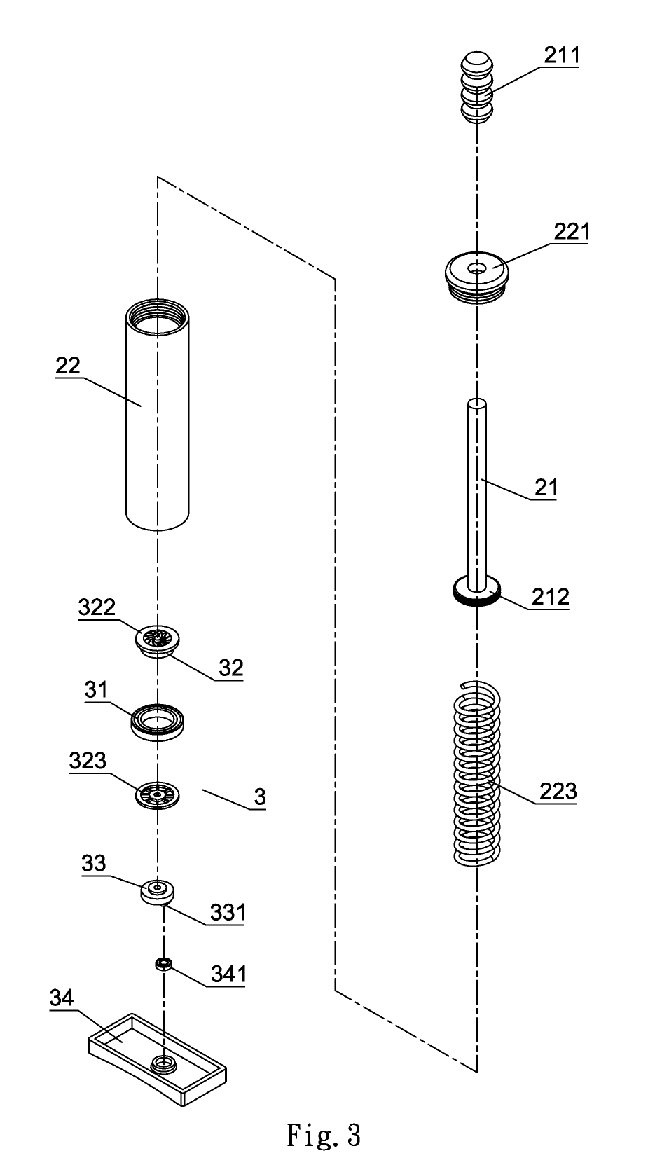

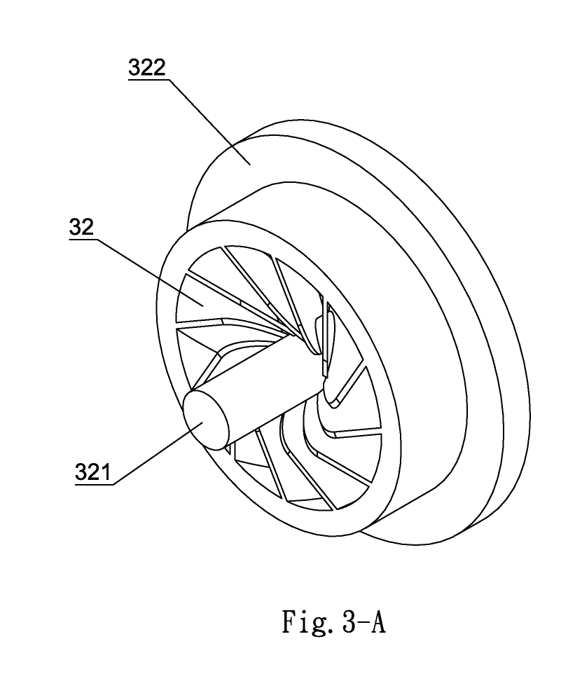

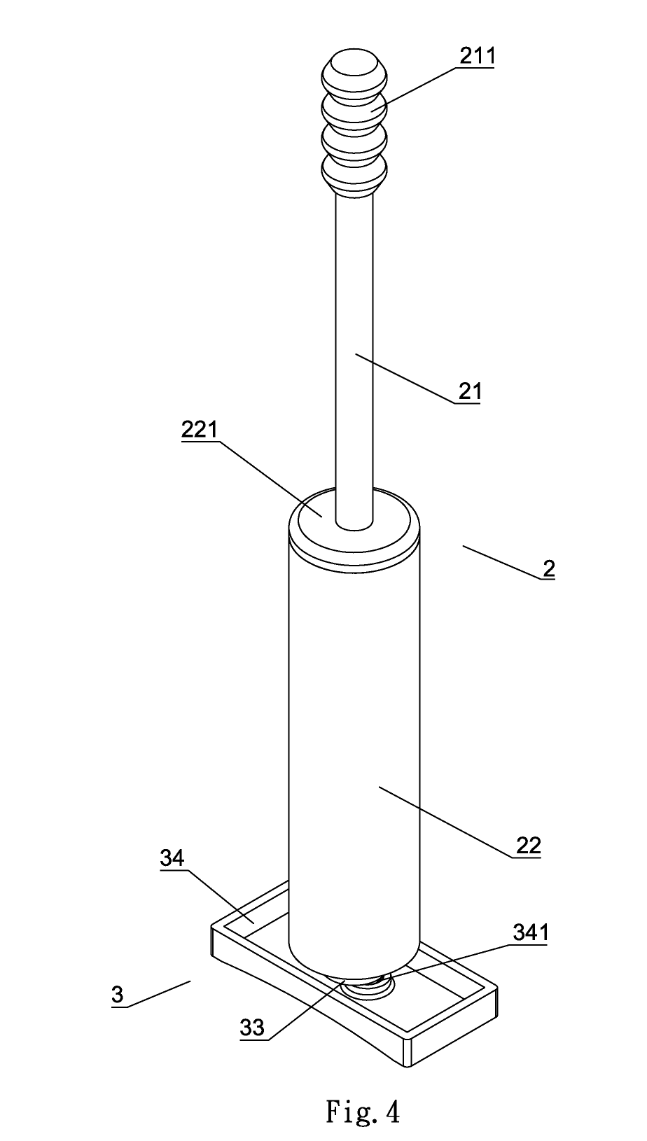

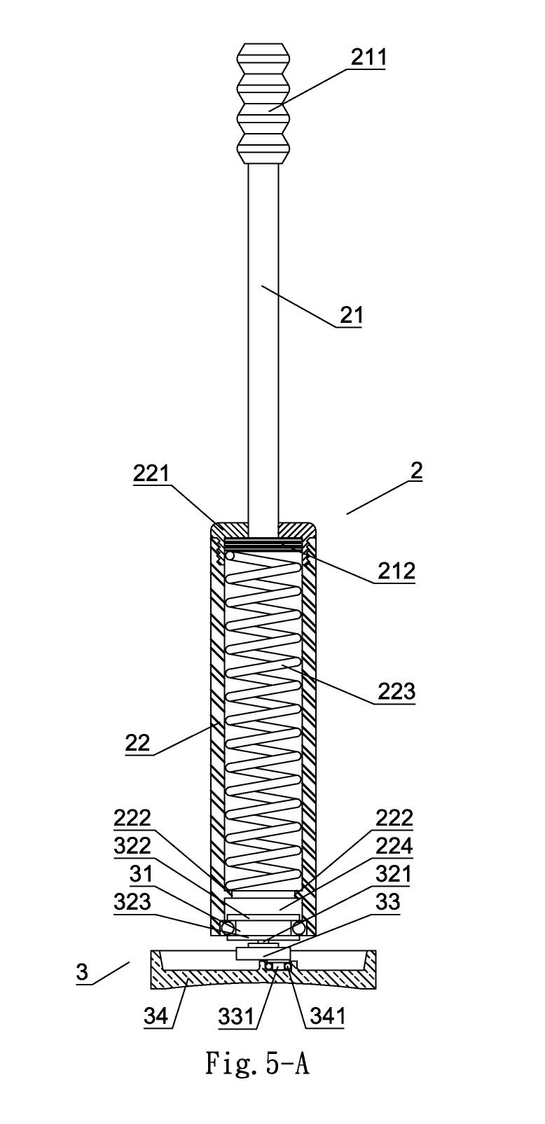

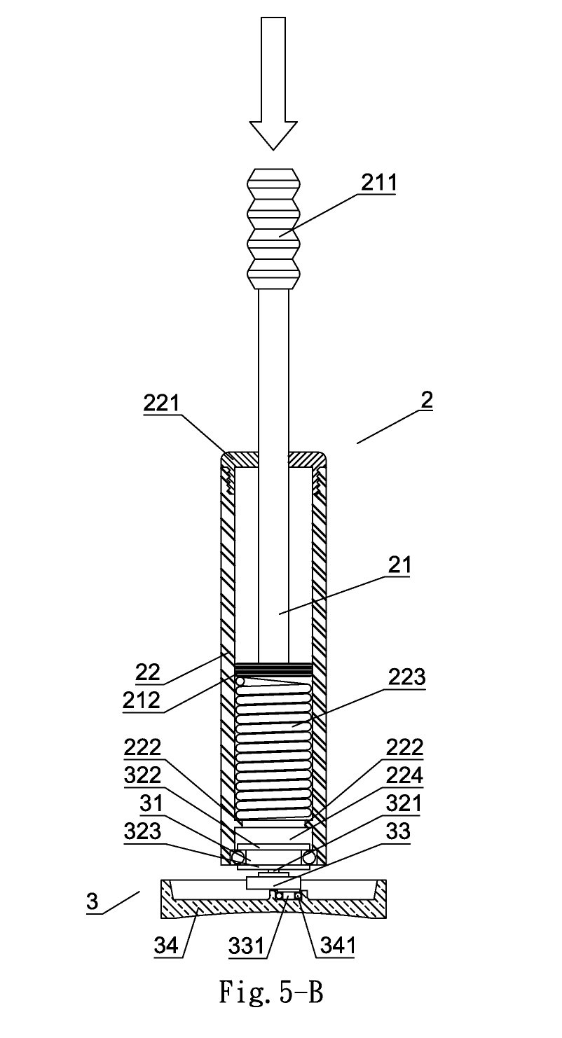

As shown in FIG. 3, FIG. 3-A, FIG. 4, FIG. 5-A, and FIG. 5-B, a manual and cyclonic massage device according to a first embodiment of the present invention comprises a retractable rod unit 2 and a massage unit 3.

The retractable rod unit 2 comprises a push rod 21. One end of the push rod 21 is connected with a handle 211 for the user to hold thereon, and another end of the push rod 21 is connected with a push member 212. The push member 212 is inserted in a hollow cylinder 22. A first end of the cylinder 22 is threadedly connected with a cap 221 to confine the push member 212 after the push rod 21 is inserted through the cap 221. A second end 224 of the cylinder 22 is provided with a stop ring 222. A spring 223 is provided between the stop ring 222 and the push member 212 for the push rod 21 to reciprocate in the cylinder 22. The massage unit 3 is connected to the second end 224 of the cylinder 22.

The massage unit 3 comprises a first bearing 31 fixed at the second end 224 of the cylinder 22. A fan 32 is provided in the first bearing 31 for supplying air to rotate its spindle. The fan 32 has an annular limit board 322 around a circumferential portion thereof to be located at one side of the first bearing 31. A limit plate 323 is fitted on a central axle 321 of the fan 32 and located at another side of the first bearing 31 to prevent disengagement. A front end of the axle 321 is connected with an eccentric block 33 having an eccentric axle 331. The eccentric axle 331 is pivotally connected with a second bearing 341 which is disposed at a central portion of a massage block 34. The massage device of the present invention can massage the user's arm, neck, chest, waist, abdomen, and so on.

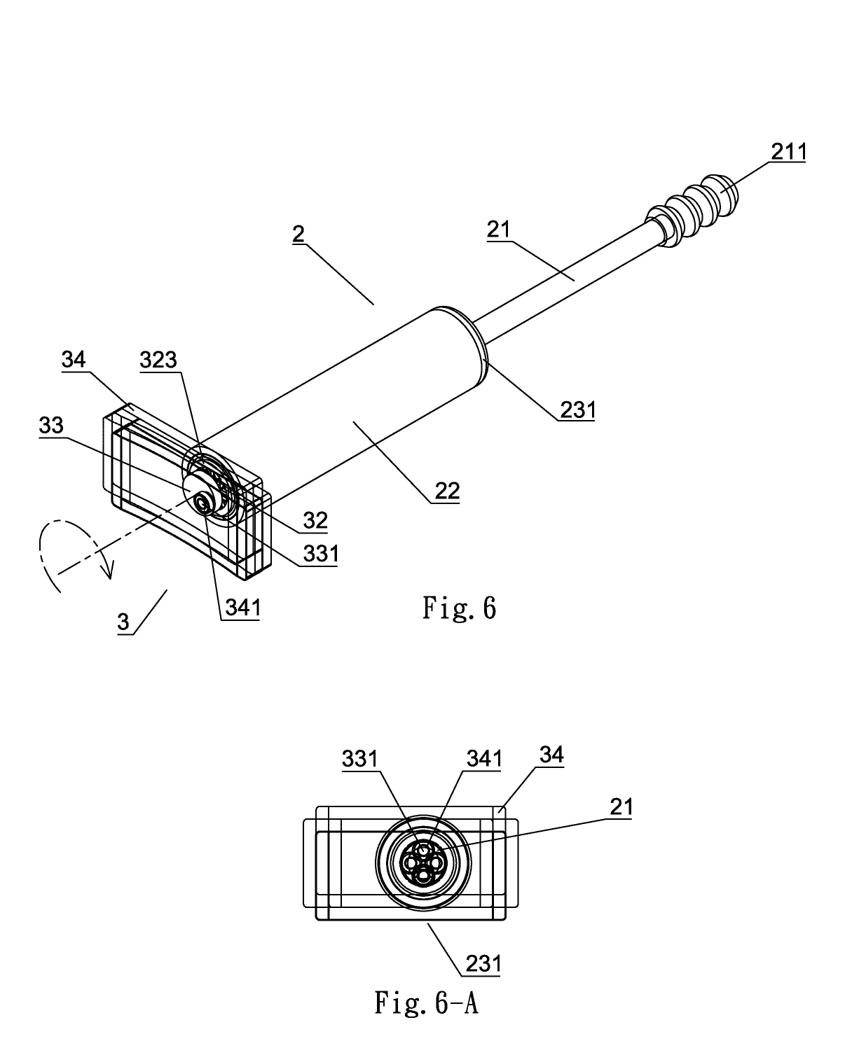

Referring to FIG. 5A, FIG. 5B, FIG. 6 and FIG. 6A, the push rod 21 of the retractable rod unit 2 is inserted through the cap 221, and the push member 212 is inserted in the cylinder 22 to be against one end of the spring 223. The first bearing 31 of the massage unit 3 is fixedly connected to the second end 224. The massage block 34 is against a desired massage portion of the user. The user grasps the handle 211 with his/her hand. When applying a force inward, the push rod 21 will be moved inward and pushed reversely by the elastic force of the spring 223. The push member 212 connected to the push rod 21 pushes air toward the fan 32. The fan 32 is rotated to drive the eccentric axle 331 of the eccentric block 33 to turn. The eccentric axle 331 drives the second bearing 341 to turn the massage block 34, so the massage block can massage the desired massage portion. When the push rod 21 is released, the push member 212 is pushed back by the spring 223. The push member 22 brings the push rod 21 to move outward. Meanwhile, the push member 212 inhales air for the fan 32 to turn reversely. The eccentric axle 331 of the eccentric block 33 is also turned reversely. The eccentric axle 331 drives the second bearing 341 to turn the massage block 34 reversely, so the massage block 34 can massage the abdomen reversely. The present invention provides an eccentric motion without resistance to massage the user's arm or neck.

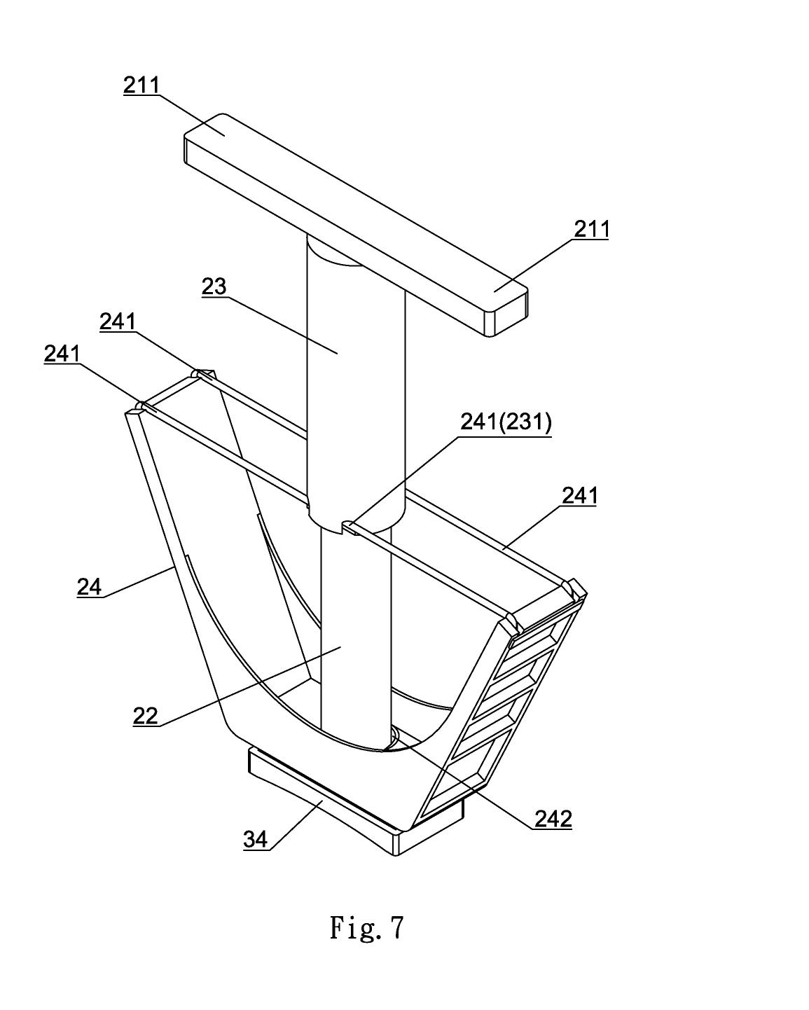

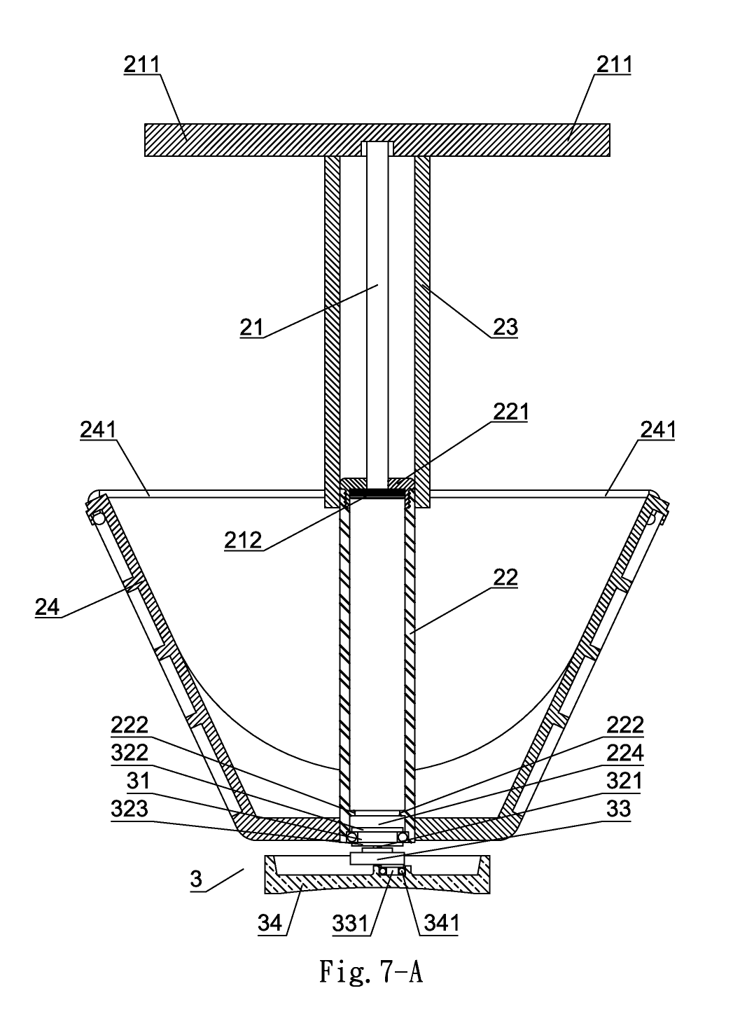

FIG. 7 and FIG. 7-A show a second embodiment of the present invention. One end of the push rod 21 of the retractable rod unit 2 is provided with a T-shaped rod which has two handles 211 at two ends thereof for the user to grasp thereon. The retractable rod unit 2 includes a protection cylinder 23 which is connected with the first end of the cylinder 22. The push rod 21 is located in the protection cylinder 23. The protection cylinder 23 has a bottom end formed with two grooves 231 to receive two resilient strips 241 of a bow-shaped frame 24. The second end of the cylinder 22 is connected to an opening 242 disposed at a central portion of the bow-shaped frame 24. The bow-shaped frame 24 functions as the spring 223 in the cylinder 22, providing the elastic force and restore force to the retractable rod unit 2 when being retraced inward or released.

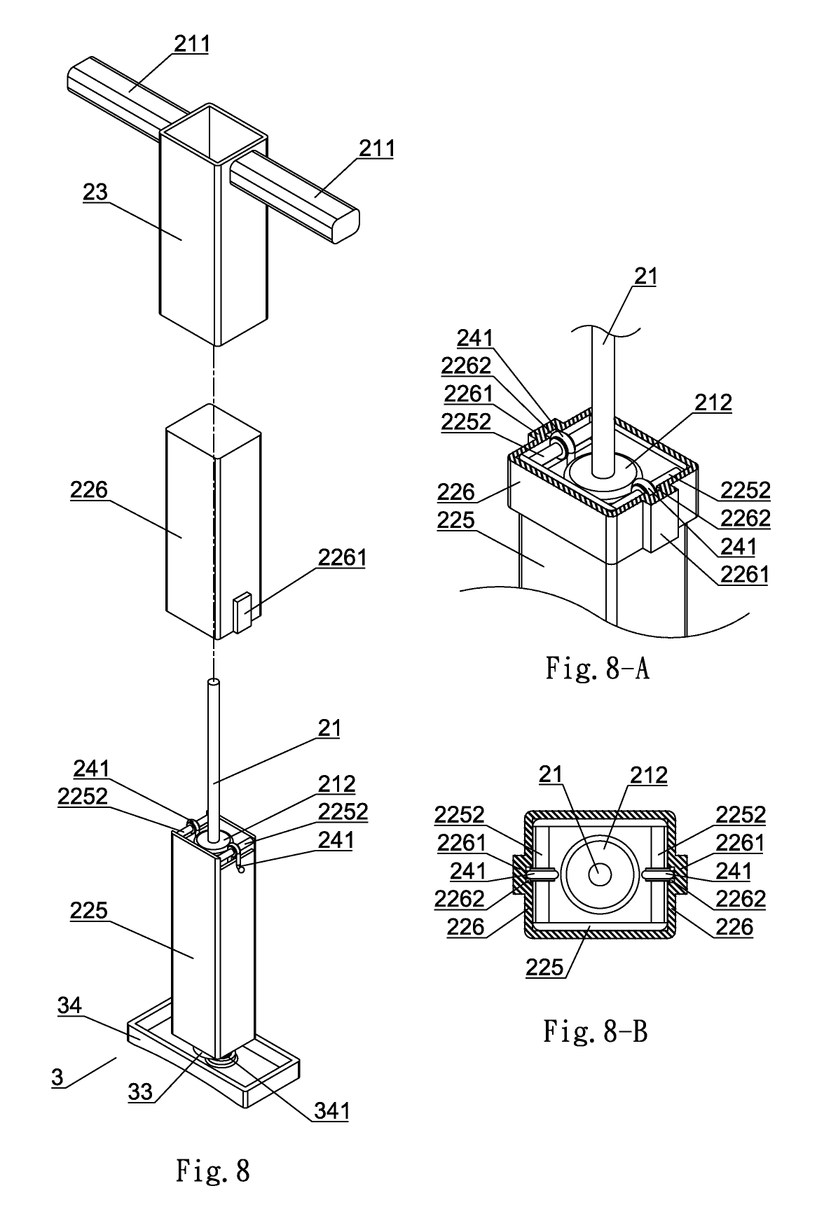

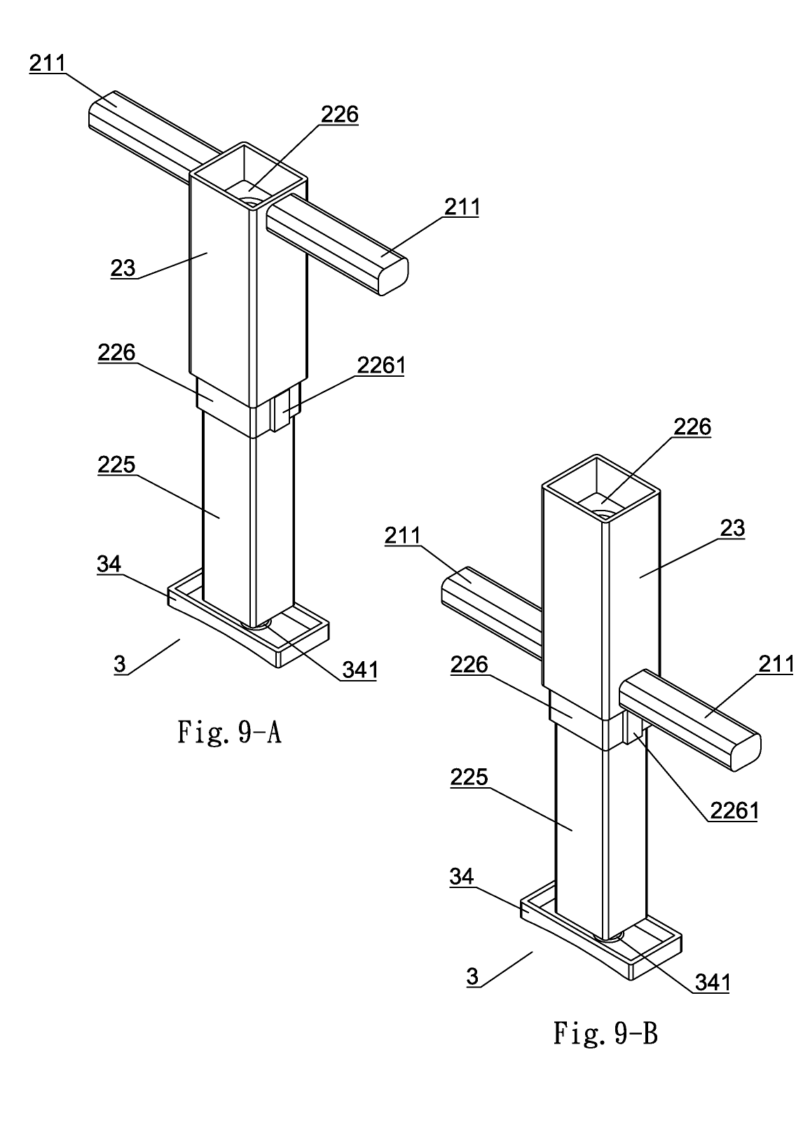

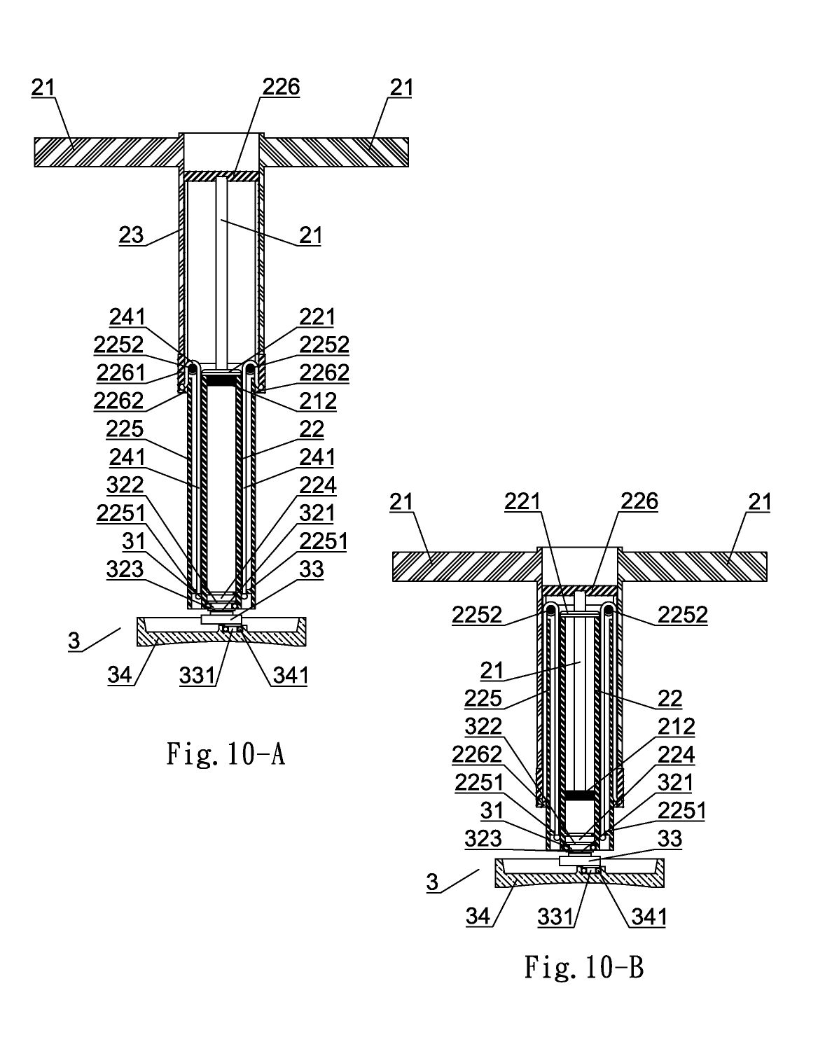

FIG. 8, FIG. 8-A, FIG. 8-B, FIG. 9-A, FIG. 9-B, FIG. 10-A and FIG. 10-B show a third embodiment. The retractable rod unit 2 includes a hollow protection cylinder 23 which has a T-shaped rod at one end thereof. The T-shaped rod has two handles 211 at two ends thereof for the user to grasp thereon. The protection cylinder 23 is fitted on a retractable cylinder 226. The retractable cylinder 226 is fitted on an outer cylinder 225. The retractable cylinder 226 has two inner engaging grooves 2262 and two outer engaging blocks 2261 at two sides thereof. The engaging blocks 2261 are adapted to hold against a bottom edge of the protection cylinder 23. One end of the push rod 21 is connected to a top of the protection cylinder 23, and another end of the push rod 21 is connected with the push member 212 and inserted in the cylinder 22. The cylinder 22 is connected with a fixing plate 2251 to connect with the outer cylinder 225. Two sides of a top of the outer cylinder 225 are pivotally connected with a pair of fixed pulleys 2252 for two resilient strips 241 to sit thereon. Two ends of each resilient strip 241 are connected to the fixing plate 2251 and the bottom of the retractable cylinder 226, respectively. The resilient strips 241 are reciprocated in the engaging grooves 2261 to function as the spring 223 in the cylinder 22, providing the elastic force and restore force to the retractable rod unit 2 when being retraced inward or released. The T-shaped rod of the protection cylinder 23 can be reversely fitted on the retractable cylinder 226 to shorten the distance.

Accordingly, the present invention can massage the user's arm, neck, chest, waist, abdomen and son on, and can be operated clockwise or counterclockwise.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A manual and cyclonic massage device, comprising a retractable rod unit and a massage unit, the retractable rod unit comprising a push rod, one end of the push rod being connected with a handle, another end of the push rod being connected with a push member, the push member being inserted in a hollow cylinder, a first end of the cylinder is threadedly connected with a cap to confine the push member after the push rod is inserted through the cap, a second end of the cylinder being provided with a stop ring, a spring being provided between the stop ring and the push member, a first bearing of the massage unit being connected to the second end of the cylinder, a fan being provided in the first bearing, the fan having an annular limit board around a circumferential portion thereof to be located at one side of the first bearing, a limit plate being fitted on a central axle of the fan and located at another side of the first bearing, a front end of the axle being connected with an eccentric block having an eccentric axle, the eccentric axle being pivotally connected with a second bearing which is disposed at a central portion of a massage block, thereby, when applying a force inward, the push rod being moved inward and pushed reversely by an elastic force of the spring, the push member connected to the push rod pushing air toward the fan, the fan being rotated to drive the eccentric axle of the eccentric block to turn, the eccentric axle driving the second bearing to turn the massage block so that the massage block being adapted to massage a desired massage portion, the push member being pushed back by the spring, the push member bringing the push rod to move outward, the push member inhaling air for the fan to turn reversely, the eccentric axle driving the second bearing to turn the massage block reversely.

2. A manual and cyclonic massage device, comprising a retractable rod unit mounted at a central portion of a bow-shaped frame and a massage unit, the retractable rod unit comprising a push rod, one end of the push rod being provided with a T-shaped rod which has two handles at two ends thereof, the retractable rod unit including a protection cylinder which is connected with a first end of a cylinder, the push rod being located in the protection cylinder, the protection cylinder having a bottom end formed with two grooves to receive two resilient strips of the bow-shaped frame, the first end of the cylinder being threadedly connected with a cap to confine the push member after the push rod is inserted through the cap, a second end of the cylinder being connected to an opening disposed at the central portion of the bow-shaped frame, the second end of the cylinder being provided with a stop ring, a first bearing of the massage unit being connected to the second end of the cylinder, a fan being provided in the first bearing, the fan having an annular limit board around a circumferential portion thereof to be located at one side of the first bearing, a limit plate being fitted on a central axle of the fan and located at another side of the first bearing, a front end of the axle being connected with an eccentric block having an eccentric axle, the eccentric axle being pivotally connected with a second bearing which is disposed at a central portion of a massage block, thereby, when applying a force inward, the push rod being moved inward and pushed reversely by an elastic force of the spring, the push member connected to the push rod pushing air toward the fan, the fan being rotated to drive the eccentric axle of the eccentric block to turn, the eccentric axle driving the second bearing to turn the massage block so that the massage block being adapted to massage a desired massage portion, the push member being pushed back by the spring, the push member bringing the push rod to move outward, the push member inhaling air for the fan to turn reversely, the eccentric axle driving the second bearing to turn the massage block reversely.

3. A manual and cyclonic massage device, comprising a retractable rod unit and a massage unit, the retractable rod unit including a hollow protection cylinder which has a T-shaped rod at one end thereof, the T-shaped rod has two handles at two ends thereof, the protection cylinder being fitted on a retractable cylinder, the retractable cylinder being fitted on an outer cylinder, the retractable cylinder having two inner engaging grooves and two outer engaging blocks at two sides thereof, the engaging blocks being adapted to hold against a bottom edge of the protection cylinder, one end of a push rod being connected to a top of the protection cylinder, another end of the push rod being connected with a push member and inserted in a cylinder, a first end of the cylinder being threadedly connected with a cap to confine the push member after the push rod is inserted through the cap, a second end of the cylinder being provided with a stop ring, the cylinder being connected with a fixing plate to connect with the outer cylinder, two sides of a top of the outer cylinder being pivotally connected with a pair of fixed pulleys for two resilient strips to sit thereon, two ends of each of the resilient strips being connected to the fixing plate and a bottom of the retractable cylinder respectively, the resilient strips being reciprocated in the engaging grooves, a first bearing of the massage unit being connected to the second end of the cylinder, a fan being provided in the first bearing, the fan having an annular limit board around a circumferential portion thereof to be located at one side of the first bearing, a limit plate being fitted on a central axle of the fan and located at another side of the first bearing, a front end of the axle being connected with an eccentric block having an eccentric axle, the eccentric axle being pivotally connected with a second bearing which is disposed at a central portion of a massage block, thereby, when applying a force inward, the push rod being moved inward and pushed reversely by an elastic force of the spring, the push member connected to the push rod pushing air toward the fan, the fan being rotated to drive the eccentric axle of the eccentric block to turn, the eccentric axle driving the second bearing to turn the massage block so that the massage block being adapted to massage a desired massage portion, the push member being pushed back by the spring, the push member bringing the push rod to move outward, the push member inhaling air for the fan to turn reversely, the eccentric axle driving the second bearing to turn the massage block reversely.

4. The manual and cyclonic massage device as claimed in claim 3, wherein the T-shaped rod of the protection cylinder is reversely fitted on the retractable cylinder.
